(19) United States
(12) Patent Application Publication
(10) Pub. No.: US 2006/0015593 A1
(43) Pub. Date: Jan. 19, 2006

(54) Three dimensional surface indicating probability of breach of service level

(75) Inventors: Paul Darius Vytas, Toronto (CA); Paul Ming Chen, Markham (CA); Andrew Niel Trossman, North York (CA)

Correspondence Address: Jeffrey S. LaBaw;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/870,224

(22) Filed: Jun. 17, 2004

(51) Int. Cl. G06F 15/177

(52) U.S. Cl. 709/221

(57) ABSTRACT

There is provided a data processing method, system and article of manufacture for service level management using probability of breach of service level for an application in a computer data centre. The method comprising obtaining one or more metrics associated with one or more resources associated with a data centre. Then generating a three dimensional surface representative of the metrics. The three dimensional surface is used to describe the variance in the probability of breaching a service level when compared to the number of resources allocated to the application and time. Using the described surface allows decision making logic to evaluate trade-offs when determining resource allocations. Discipline specific modules are used to translate collected metrics for the respective disciplines into a probability of breach of service level surface which is then presented to decision making logic. Responsive to the three dimensional representation surface a determination is made for a best fit solution to for configuring the computer data centre using a probability of breach of service level. The best fit solution is then communicated to one or more components of the data centre in the form of an action request to reconfigure the resources of the infrastructure of the data centre.

### FIELD OF THE INVENTION

This present invention relates generally to resource management toward service level attainment and more specifically to application resource management using a three dimensional surface to indicate the probability of breach of a service level.

### BACKGROUND OF THE INVENTION

Managing the allocation of resources within a computer data centre may be a challenge due to the complexity of components and the variable nature of demand for the scarce resources comprising the data centre. In many cases the resource required most often is the resource that is the least available. In other cases it is not readily apparent which resource should be changed to alleviate a current undesirable situation. In some other cases the addition or removal of a resource may in fact add to the problem being addressed. In most cases decisions to take specific action would be enhanced by having received notification of an impending problem.

Making automated decisions for provisioning resources between multiple applications in operation within a data centre can be especially difficult. The difficulty arises when differing disciplines, such as performance, availability and fault management, must also be considered concurrently with a variety of monitoring systems associated with components of the data centre.

Typically decision making or decision assist schemes are bound to a specific metric, such as server utilization or response time and to a specific discipline such as performance. This narrow focus limits the capabilities of such schemes and their applicability in a large diverse data centre.

It would therefore be highly desirable to have a means for allowing detailed information of resources used by applications to be more effectively used to better manage the resources within a diverse data centre.

### SUMMARY OF THE INVENTION

Conveniently, software exemplary of an embodiment of the present invention uses the probability of a breach of a service level (SLA) to provide a comparison between a need for resources being used among applications and service level objectives in a data centre.

A three dimensional surface representative of relationships between metrics is used to describe the variance in the probability of breaching a service level when compared to the number of resources allocated to the application and time. Using the described surface allows decision making logic to evaluate trade-offs when determining resource allocations. Discipline specific modules are used to translate collected metrics for the respective disciplines into a probability of breach of a service level surface which is then presented to decision making logic to determine a course of action.

In one embodiment of the present invention there is provided a data processing method for service level management using probability of breach of service level for an application in a computer data centre, the method comprising: obtaining one or more metrics each associated with a respective resource associated with a data centre, one of the metrics being probability of breach of service level; generating an n-dimensional representation of a relationship of the metrics; responsive to the n-dimensional representation determining a best fit solution for configuring the computer data centre using a probability of breach of service level; and communicating the best fit solution to one or more components of the data centre to reconfigure the respective resources toward attaining the service level.

In another embodiment of the present invention there is provided a data processing system for service level management using probability of breach of service level for an application in a computer data centre, the data processing system comprising: a means for obtaining one or more metrics each associated with a respective resource associated with a data centre, one of the metrics being probability of breach of service level; a means for generating an n-dimensional representation of a relationship of the metrics; responsive to the n-dimensional representation a means for determining a best fit solution for configuring the computer data centre using a probability of breach of service level; and a means for communicating the best fit solution to one or more components of the data centre to reconfigure the respective resources toward attaining the service level.

In another embodiment of the present invention there is provided an article of manufacture for directing a data processing system for service level management using probability of breach of service level for an application in a computer data centre, the article of manufacture comprising: a data processing system usable medium embodying one or more instructions executable by the data processing system, the one or more instructions comprising: data processing system executable instructions for obtaining one or more metrics each associated with a respective resource associated with a data centre, one of the metrics being probability of breach of service level; data processing system executable instructions for generating an n-dimensional representation of a relationship of the metrics; responsive to the n-dimensional representation data processing system executable instructions for determining a best fit solution for configuring the computer data centre using a probability of breach of service level; and data processing system executable instructions for communicating the best fit solution to one or more components of the data centre to reconfigure the respective resources toward attaining the service level.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate embodiments of the present invention by example only,

FIG. 1 is a block diagram of components of a typical computer system in which an embodiment of the present invention may be implemented;

FIG. 2 is a block diagram of components of one embodiment of the present invention as may be implemented within the computer system of FIG. 1;

FIG. 3 is a block diagram of components in which another embodiment of the present invention may be implemented; and

FIG. 4 is a perspective diagram of the relationship between time, resources and probabilities as may be used in the implementation of FIG. 2 and FIG. 3.

Like reference numerals refer to corresponding components and steps throughout the drawings.

### DETAILED DESCRIPTION

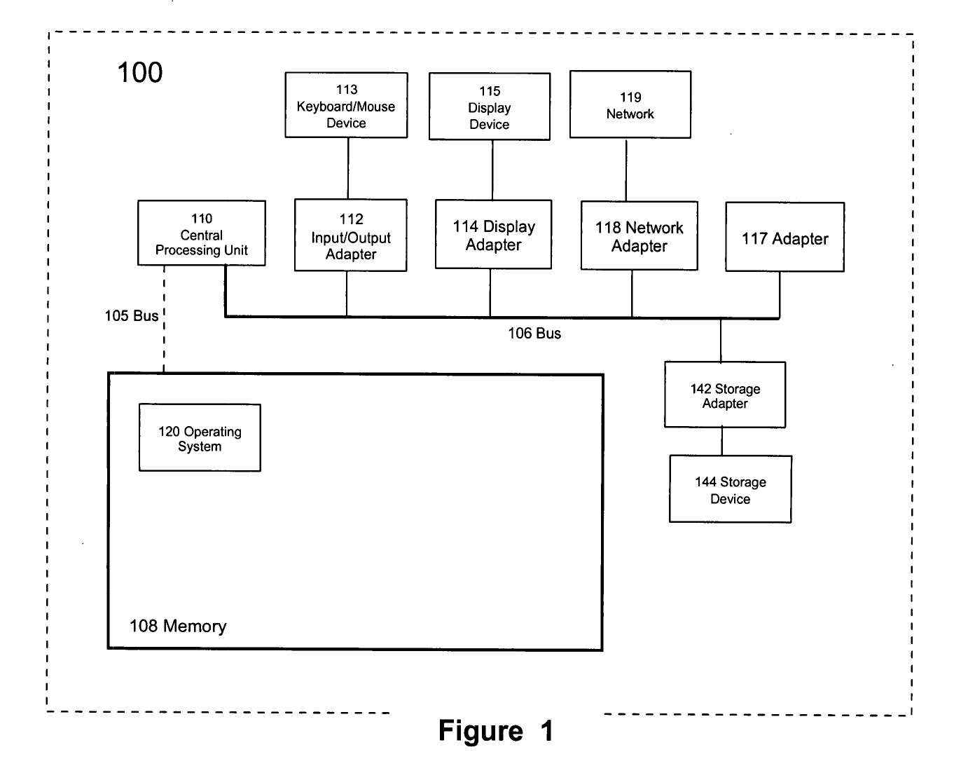

FIG. 1 depicts, in a simplified block diagram, a computer system 100 suitable for implementing embodiments of the present invention. Computer system 100 has a central processing unit (CPU) 110, which is a programmable processor for executing programmed instructions, such as instructions contained in utilities (utility programs) 126 stored in memory 108. Memory 108 can also include hard disk, tape or other storage media. While a single CPU is depicted in FIG. 1, it is understood that other forms of computer systems can be used to implement the invention, including multiple CPUs. It is also appreciated that the present invention can be implemented in a distributed computing environment having a plurality of computers communicating via a suitable network 119, such as the Internet.

CPU 110 is connected to memory 108 either through a dedicated system bus 105 and/or a general system bus 106. Memory 108 can be a random access semiconductor memory for storing components of an embodiment of the present invention. Memory 108 is depicted conceptually as a single monolithic entity but it is well known that memory 108 can be arranged in a hierarchy of caches and other memory devices. FIG. 1 illustrates that operating system 120, may reside in memory 108.

Operating system 120 provides functions such as device interfaces, memory management, multiple task management, and the like as known in the art. CPU 110 can be suitably programmed to read, load, and execute instructions of operating system 120. Computer system 100 has the necessary subsystems and functional components to implement support for an implementation of the present invention as will be described later. Other programs (not shown) include server software applications in which network adapter 118 interacts with the server software application to enable computer system 100 to function as a network server via network 119.

General system bus 106 supports transfer of data, commands, and other information between various subsystems of computer system 100. While shown in simplified form as a single bus, bus 106 can be structured as multiple buses arranged in hierarchical form. Display adapter 114 supports video display device 115, which is a cathode-ray tube display or a display based upon other suitable display technology that may be used to allow input or output to be viewed. The Input/output adapter 112 supports devices suited for input and output, such as keyboard or mouse device 113, and a disk drive unit (not shown). Storage adapter 142 supports one or more data storage devices 144, which could include a magnetic hard disk drive or CD-ROM drive although other types of data storage devices can be used, including removable media for storing data such as but not limited to, resource management and configuration data.

Adapter 117 is used for operationally connecting many types of peripheral computing devices to computer system 100 via bus 106, such as printers, bus adapters, and other computers using one or more protocols including Token Ring, LAN connections, as known in the art. Network adapter 118 provides a physical interface to a suitable network 119, such as the Internet. Network adapter 118 includes a modem that can be connected to a telephone line for accessing network 119. Computer system 100 can be connected to another network server via a local area network using an appropriate network protocol and the network server can in turn be connected to the Internet. FIG. 1 is intended as an exemplary representation of computer system 100 by which embodiments of the present invention can be implemented. It is understood that in other computer systems, many variations in system configuration are possible in addition to those mentioned here.

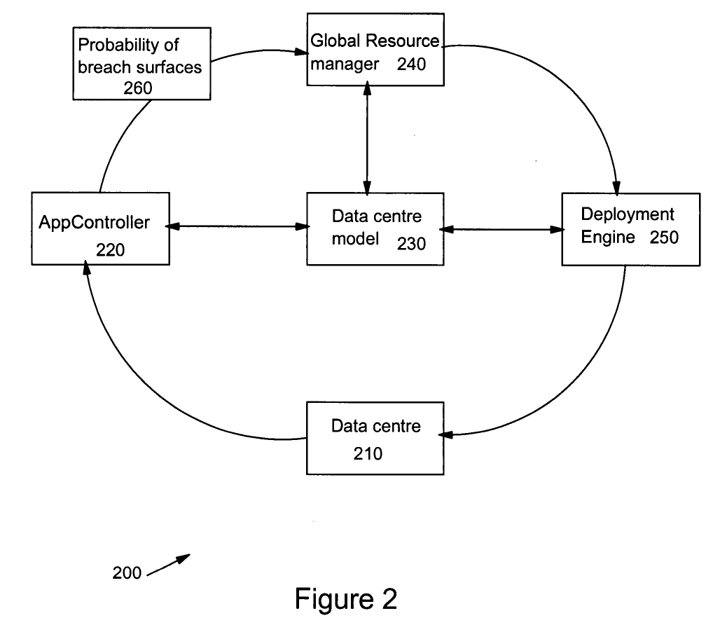

FIG. 2 illustrates an overview of components as may be found in an implementation of an embodiment of the present invention. System 200 comprises elements as depicted in FIG. 1 in which Data Centre 210 comprises the physical components necessary to provide structure of sufficient complexity to provide an operational environment in which applications as used for business transactions can exist. Although not shown Data Centre 210 also comprises network links to other systems as well as may be appreciated by those skilled in the art. It is the resources of Data Centre 210 that are of interest to be managed for effective utilization by the implementation of an embodiment of the present invention.

Data centre 210 produces various statistical information or measurement data, such as but not limited to, utilization of resources and quantities of resources which is captured and then processed by AppController 220. AppController 220 receives the metrics from the managed components of Data centre 210 either by polling the various components explicitly, by receiving event notifications containing such data or other means so as to make the necessary information available for processing. The acquisition means is not as important as having the actual data; therefore how the data is obtained is not significant to an implementation of an embodiment of the present invention.

AppController 220 combines the metrics for the various disciplines obtained from Data Centre 210 with an internal model of application workload to estimate the service level for differing numbers of resources, such as servers. Differing implementations may be used to suit different types of applications. For example, an adaptive queuing model may be used to model a grid service offering to estimate how the service time may vary according to the number of servers in the grid service. In another example a streaming video application may be modelled using a simple ratio model such as doubling of the number of servers causes streaming throughput to double also. AppController 220 is capable of providing an estimated number of servers required for each cluster of servers for an application based on workload information and the internal model of the application. This estimate is determined based on, for each cluster, estimating the probability of breaching the service level for the application as determined for a given instance in time and specific number of servers.

Predictive information (in the context of the applications) may also be used. Typical predictive models may be used such as analysis of variance (ANOVA) in combination with auto-regression to predict arrival rates of client requests in an application, based on historical information for that application. This form of technique may be effective for predicting regular patterns such as daily or weekly usage patterns but typically adds increased complexity to implementation of AppController 220. Such techniques are may only be useful when such patterns of use are fairly regular and predictable.

Service level objectives themselves may be characterized by example such as performance objective that relate to a maximum response time allowed for an application, where the response duration is specified to be a set value per set unit of time. In another example CPU utilization may be established at a target rate or range such as between 50% and 75%. When dealing with availability objectives these are typically expressed in some coarse form such as prevention of a single point of failure condition by guaranteeing that a “hot” backup server is always available. In addition the objectives may vary in accordance with the time of day, such as when core hours are defined for an on-line service to be available at a higher level of availability than outside the defined core hours.

Input from Data Centre Model 230 is provided to AppController 220 to allow AppController 220 to perform the necessary calculations to produce Probability of breach surfaces 260. Data Centre Model 230 may be implemented as a database or other form of repository providing information on the current configuration and state of the infrastructure of Data Centre 210. This information may include the specific resource pool to which each server cluster belongs, the actual number of servers being used by a specific cluster, the permitted range of servers allowed in a cluster, the number of idle servers in the various resource pools and the priority of an application to which a specific cluster belongs.

Probability of breach of the service level is then calculated based on how close an estimated service level is to an objective. Probability of breach surfaces 260 is the graphic result of the computations involving the previously presented metrics, disciplines and application model. A three dimensional representation of the metrics is calculated using known techniques from the inputs just described to produce a three dimensional surface object. The surface represents the data tuple in the form of x, y and z values (shown in FIG. 2 described later). Probability of breach surfaces 260 may provide interpreted or extrapolated results for data values for which it did not receive any input. For example the surface created does not require the mapping of all possible points between two pints to produce a surface between those points.

Probability of breach surfaces 260 is then made available to Global Resource Manager 240 which seeks to optimize utilization of resources under its control. Global Resource Manager 240 interrogates Probability of breach surfaces 260 providing input values for resources and time. The output for such a pairing of data values is the probability of breach of service level at that point. Within Global Resource manager 240 there is an optimizer designed to segregate information by grouping into sub-groups according to resource pool allowing resource pool optimizers to function for a respective resource pool. A pool resource optimizer is designed to find the optimal set of infrastructure changes for the respective resource pool and therefore the best allocation of resources within the data centre taking into account the implied cost of a service level breach and the application priority.

In an implementation of an embodiment of the present invention a decision tree containing nodes comprised of appropriate infrastructure changes may be created and the tree traversed. Traversal is typically governed by best fit analysis of the given nodes. Additionally a timeout parameter may be used to limit the time allowed to traverse the decision tree. If a timeout has been implemented, the best fit encountered during the prioritization will be selected. A traversal algorithm may be used to specify the ordering of nodes so that the best candidate nodes are searched first.

The use of the described optimizer could also be avoided when there are a sufficient number of spare servers available. Once a set of infrastructure changes is available it is reviewed to determine if there are any changes to the server clusters that may be pending. The review is also used to ensure there are only as many add server requests as there are available (usually idle) servers. This simplification removes the necessity of scheduling remove and add server requests in advance to take into consideration the amount of time required to move a specific server.

In one embodiment, upon completion of review of the selected infrastructure changes, Global resource manager 240 converts the proposed changes into deployment requests which may be in the form of logical device operations. Deployment requests may be sent to an intermediary such as Deployment Engine 250 for subsequent processing or directly to the specified devices as in Data Centre 210. If dealing with an intermediary such as Deployment Engine 250, logical device operations may be used instead of device specific commands thereby separating the services of the Global resource manager 240 from actual knowledge of specific devices contained within Data Centre 210.

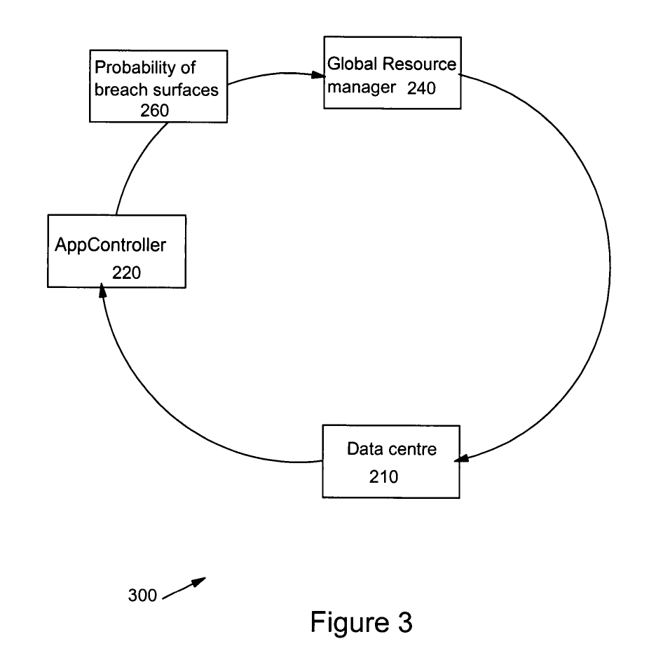

As seen in FIG. 3 there may not be Data Centre Model 230 or Deployment Engine 250 in a given implementation. In such cases the collection of resource based information would come directly from Data Centre 210 into AppController 220 and operation requests for infrastructure changes would come directly from Global resource manager 240 to the various physical components of Data Centre 210. Global resource manager 240 would in this case have to be enabled to communicate directly with the plurality of devices to be controlled.

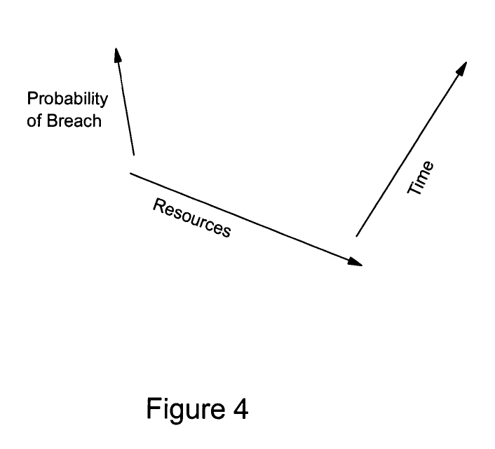

Referring now to FIG. 4 is the three dimensional surface calculated by AppController 220 for use by Global resource manager 240. A surface is calculated for each cluster of servers associated with each application to allow for proper resource management. It may be considered as a resource based view of an application taking into account the service level objectives of the application. When interpreting the graph for a given instance of a data value pair of number of servers and units of time there is a corresponding probability of breaching the service level associated with the respective application.

FIG. 4 may also be used to illustrate the impact to the probability value of varying the number of servers per unit of time by traversing the number of resources axis for a given time unit. If a specific implementation of AppController 220 can predict the future demand and behaviour of the application then it can describe the prediction using the time axis of the probability surface. For simple AppController 220 implementations the probability of breach may typically be described as not changing over time.

For example using the graph provided one can see that adding servers may not provide much impact until some units of time have passed as indicated by the step or drop in the surface shape. In similar manner one can surmise that adding some number of servers does not help until a threshold has been passed as indicated along the number of resources (server) axis.

In general the graph is a visual representation indicating that by providing an additional resource over time the probability of service level breach is reduced which is what would be expected. This may not be the case however if the resource being added, such as communication links, causes an increase in workload that cannot be handled by a busy downstream component, such as a web server. In this case the added links compound the problem of the busy web server by increasing demand for service. Applications having multiple clusters need to have the impact of the associated cluster changes summarized on the overall application level. In a similar manner scenarios with multiple applications and their associated changes have to be analysed separately as the model does not aggregate results across clusters or applications.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A data processing method for service level management using probability of breach of service level for an application in a computer data centre, the method comprising:
obtaining one or more metrics each associated with a respective resource associated with a data centre, one of the metrics being probability of breach of service level;
generating an n-dimensional representation of a relationship of the metrics;
responsive to the n-dimensional representation determining a best fit solution for configuring the computer data centre using a probability of breach of service level; and
communicating the best fit solution to one or more components of the data centre to reconfigure the respective resources toward attaining the service level.

2. The data processing method of claim 1 wherein the best fit solution further comprises an optimal set of infrastructure changes directed to a specific resource pool of components of the data centre.

3. The data processing method of claim 1 wherein the analysing step further comprises:
grouping the metrics into sub-groups according to a resource pool;
passing the grouped metrics to a respective pool optimizer;
generating a decision tree from the grouped metrics containing at least one node for a respective pool; and
calculating a fitness for the at least one node.

4. The data processing method of claim 1 wherein generating further comprises:
selectively pruning the metrics to limit the search space of the decision tree.

5. The data processing method of claim 1 wherein the generating further comprises:
imposing a time limit for traversal of the at least one nodes in the decision tree.

6. The data processing method of claim 1 wherein the step of obtaining further comprises obtaining information from a data centre model.

7. The data processing method of claim 1 wherein communicating further comprises transmitting the best fit solution for configuring the computer data centre from a resource manager to a deployment engine, each in communication with a data centre model.

8. The method of claim 1 wherein the n-dimensional representation further comprises n-axis each axis corresponding to a metric category, one category being probability of breach of service level.

9. The method of claim 1 wherein the n-dimensional representation further comprises:
a three dimensional representation; and
each axis representing a one of time, resource, and probability of breach of service level.

10. A data processing system for service level management using probability of breach of service level for an application in a computer data centre, the data processing system comprising:
a means for obtaining one or more metrics each associated with a respective resource associated with a data centre, one of the metrics being probability of breach of service level;
a means for generating an n-dimensional representation of a relationship of the metrics;
responsive to the n-dimensional representation a means for determining a best fit solution for configuring the computer data centre using a probability of breach of service level; and
a means for communicating the best fit solution to one or more components of the data centre to reconfigure the respective resources toward attaining the service level.

11. The data processing system of claim 10 wherein the best fit solution further comprises an optimal set of infrastructure changes directed to a specific resource pool of components of the data centre.

12. The data processing system of claim 10 wherein the means for analysing further comprises:
a means for grouping the metrics into sub-groups according to a resource pool;
a means for passing the grouped metrics to a respective pool optimizer;
a means for generating a decision tree from the grouped metrics containing at least one node for a respective pool; and
a means for calculating a fitness for the at least one node.

13. The data processing system of claim 10 wherein the means for generating further comprises:
a means for selectively pruning the metrics to limit the search space of the decision tree.

14. The data processing system of claim 10 wherein the means for generating further comprises:
a means for imposing a time limit for traversal of the at least one nodes in the decision tree.

15. The data processing system of claim 10 wherein the means for obtaining further comprises means for obtaining information from a data centre model.

16. The data processing system of claim 10 wherein the means for communicating further comprises means for transmitting the best fit solution for configuring the computer data centre from a resource manager to a deployment engine, each in communication with a data centre model.

17. The data processing system of claim 10 wherein the n-dimensional representation further comprises n-axis each axis corresponding to a metric category, one metric category being probability of breach of service level.

18. The data processing system of claim 10 wherein the n-dimensional representation further comprises:
a three dimensional representation; and
each axis representing a one of time, resource, and probability of breach of service level.

19. An article of manufacture for directing a data processing system for service level management using probability of breach of service level for an application in a computer data centre, the article of manufacture comprising:
a data processing system usable medium embodying one or more instructions executable by the data processing system, the one or more instructions comprising:
data processing system executable instructions for obtaining one or more metrics each associated with a respective resource associated with a data centre, one of the metrics being probability of breach of service level;
data processing system executable instructions for generating an n-dimensional representation of a relationship of the metrics;
responsive to the n-dimensional representation data processing system executable instructions for determining a best fit solution for configuring the computer data centre using a probability of breach of service level; and
data processing system executable instructions for communicating the best fit solution to one or more components of the data centre to reconfigure the respective resources toward attaining the service level.

20. The article of manufacture of claim 19 wherein the best fit solution further comprises an optimal set of infrastructure changes directed to a specific resource pool of components of the data centre.

21. The article of manufacture of claim 19 wherein the data processing system executable instructions for analysing further comprises:
data processing system executable instructions for grouping the metrics into sub-groups according to a resource pool;
data processing system executable instructions for passing the grouped metrics to a respective pool optimizer;
data processing system executable instructions for generating a decision tree from the grouped metrics containing at least one node for a respective pool; and
data processing system executable instructions for calculating a fitness for the at least one node.

22. The article of manufacture of claim 19 wherein the data processing system executable instructions for generating further comprises:
data processing system executable instructions for selectively pruning the metrics to limit the search space of the decision tree.

23. The article of manufacture of claim 19 wherein the data processing system executable instructions for generating further comprises:
data processing system executable instructions for imposing a time limit for traversal of the at least one nodes in the decision tree.

24. The article of manufacture of claim 19 wherein the data processing system executable instructions for obtaining further comprises data processing system executable instructions for obtaining information from a data centre model.

25. The article of manufacture of claim 19 wherein the data processing system executable instructions for communicating further comprises data processing system executable instructions for transmitting the best fit solution for configuring the computer data centre from a resource manager to a deployment engine, each in communication with a data centre model.

26. The article of manufacture of claim 19 wherein the n-dimensional representation further comprises n-axis each axis corresponding to a metric category, one metric category being probability of breach of service level.

27. The article of manufacture of claim 19 wherein the n-dimensional representation further comprises:
a three dimensional representation; and
each axis representing a one of time, resource, and probability of breach of service level.
